(19) United States
(12) Patent Application Publication
(10) Pub. No.: US 2022/0264304 A1
(43) Pub. Date: Aug. 18, 2022

(54) GROUP COMMUNICATION METHOD AND RELATED PRODUCTS

(71) Applicant: HUAWEI TECHNOLOGIES CO., LTD., Shenzhen (CN)

(72) Inventors: Zhongding LEI, Singapore (SG); Gurbakshish Singh TOOR, Singapore (SG)

(21) Appl. No.: 17/736,693

(22) Filed: May 4, 2022

Related U.S. Application Data
(63) Continuation of application No. PCT/CN2019/116816, filed on Nov. 8, 2019.

(51) Int. Cl. H04W 12/106; H04W 12/76; H04W 12/55; H04W 12/041; H04W 12/0471; H04W 12/03

(52) U.S. Cl. CPC H04W 12/106; H04W 12/76; H04W 12/03; H04W 12/041; H04W 12/0471; H04W 12/55

(57) ABSTRACT

Provided are a group communication method and related products. In the method, a first user device acquires a group identifier (ID), where the group identifier is used for identifying a group including at least the first user device and a second user device the first user device determines a current destination ID according to the group ID, and transmits to the second user device a packet carrying the current destination ID. With the group communication method and apparatus provided in the present disclosure, the application layer group ID will be converted to the destination L2 ID, thus enabling the end to end group communication.

### CROSS-REFERENCE TO RELATED APPLICATIONS

This application is a continuation of International Application No. PCT/CN2019/116816, filed on Nov. 8, 2019, the disclosure of which is hereby incorporated by reference in its entirety.

### TECHNICAL FIELD

The present disclosure relates to the technical field of V2X technologies, and in particular, to a group communication method and related products.

### BACKGROUND

The so-called vehicle to everything (V2X), like the popular business to business (B2B) and business to costumer (B2C), refers to the exchange of information between cars and the outside world. The Internet of vehicles has established a new direction of automotive technology through the integration of the global positioning system (GPS) navigation technology, vehicle-to-vehicle communication technology, wireless communication and remote sensing technology, achieving manual driving and automatic driving compatibility.

In TR 23.786 of the 3rd generation partnership project (3GPP), which focuses on study on architecture enhancements for the evolved packet system (EPS) and the 5G system (5GS) to support advanced V2X services, solution #21 “Group communication enhancement for NR PC5” is selected as the baseline for normative work to address KI #1 “Support of enhancement V2X (eV2X) group communication”. With reference to FIG. 5.4.1-1 as shown in TR 23,786, a group identifier provided by an application layer will be converted into a destination layer 2 identifier (L2 ID), since the lower layers cannot directly use the upper layer identifiers (IDs) However, no mechanism exists in related art for the conversion.

This background information is provided to reveal information believed by the applicant to be of possible relevance to the present disclosure. No admission is necessarily intended, nor should be construed, that any of the preceding information constitutes prior art against the present disclosure.

### SUMMARY

In view of the above, in order to solve the above problem, the present disclosure provides a group communication method and related products.

The foregoing and other objects are achieved by the subject matter of the independent claims. Further implementation forms are apparent from the dependent claims, the description and the figures.

A first aspect the present disclosure relates to a group communication method, including: acquiring, by a first user device, a group identifier (ID), where the group identifier is used for identifying a group comprising at least the first user device and a second user device; determining, by the first user device, a current destination ID according to the group ID, where the current destination ID is used for identifying the second user device in the group; and transmitting, by the first user device, to the second user device a packet carrying the current destination ID.

According to the solution provided by the present disclosure, the application layer group ID will be converted to the destination L2 ID, thus enabling the end to end group communication.

In a possible implementation form of the method according to the first aspect as such, where the determining, by the first user device, a current destination ID according to the group ID comprises: acquiring, by the first user device, at least one parameter for determining the current destination ID; and determining, by the first user device, the current destination ID according to the group ID and the at least one parameter. Where the determining, by the first user device, the current destination ID according to the group ID and the al least one parameter comprises: determining, by the first user device, whether a triggering condition is satisfied; in response to determining that the triggering condition is satisfied, generating, by the first user device, the current destination ID according to the group ID and the at least one parameter; and in response to determining that the triggering condition is not satisfied, determining, by the first user device, a previously generated destination ID as the current destination ID.

According to the solution provided by the present disclosure, the conversion of the destination ID may be performed multiple times, thus ensuring that the application layer group ID will be securely converted to the destination L2 ID and this conversion process cannot be tampered by an adversary. The adversary will not be able to link the destination L2 ID to the UE group membership thereby protecting the integrity and privacy of the member UE. The UE only decrypts the messages or listens to the messages intended for it as the destination L2 ID is not encrypted, thus reducing the computational expense and hence delay as well (although this may not apply to the first conversion process, but the subsequent conversion can benefit). Besides, the arbitrarily transmitting of the random number further secures the conversion process.

A second aspect the present disclosure relates to a group communication method, including: receiving, by a second user device, a packet carrying a current destination identifier (ID), where the current destination ID is used for identifying the second user device in a group, and the group comprises at least a first user device and the second user device and verifying, by the second user device, the current destination ID in the received packet with a local destination ID.

According to the solution provided by the present disclosure, the application layer group ID will be converted to the destination L2 ID, thus enabling the end to end group communication.

In a possible implementation form of the method according to the second aspect as such, the method further includes: acquiring, by a second user device, a group ID, where the group ID is used for identifying the group; acquiring, by the second user device, at least one parameter for determining the local destination ID; and determining, by the second user device, the local destination ID according to the group ID and the at least one parameter. Where the determining, by the second user device, the local destination ID according to the group ID and the at least one parameter comprises: determining, by the second user device, whether there exists an encrypted random number in the received packet; in response to determining that there exists an encrypted random number in the received packet, decrypting, by the second user device, the encrypted random number with the at least one parameter, and generating, by the second user device, the local destination ID based on the group ID using a hash function and the decrypted random number; and in response to determining that there does not exist an encrypted random number in the received packet, determining, by the second user device, a previously generated local destination ID as the local destination ID.

According to the solution provided by the present disclosure, the conversion of the destination ID may be performed multiple times, thus ensuring that the application layer group ID will be securely converted to the destination L2 ID and this conversion process cannot be tampered by an adversary. The adversary will not be able to link the destination L2 ID to the UE group membership thereby protecting the integrity and privacy of the member UE. The UE only decrypts the messages or listens to the messages intended for it as the destination L2 ID is not encrypted, thus reducing the computational expense and hence delay as well.

A third aspect of the present disclosure relates to a first user device, including a memory, a processor, an input interface, and an output interface. The memory, the processor, the input interface, and the output interface are connected by a bus system. The memory is configured to store an instruction, and the processor is configured to execute the instruction stored in the memory for performing the method in the above-mentioned first aspect or any possible implementation of the first aspect.

A fourth aspect of the present disclosure relates to a second user device, including a memory, a processor, an input interface, and an output interface. The memory, the processor, the input interface, and the output interface are connected by a bus system. The memory is configured to store an instruction, and the processor is configured to execute the instruction stored in the memory for performing the method in the above-mentioned second aspect or any possible implementation of the second aspect.

A fifth aspect of the present disclosure relates to a computer storage medium storing computer executable instructions which, when being executed, implement the method according to the first or the second aspect of the present disclosure and any possible implementation thereof.

A sixth aspect of the present disclosure relates to a computer program product is provided, including an instruction which, when executed on a computer, causes a computer to perform the method in the above-mentioned first or second aspect or any possible implementation thereof.

### BRIEF DESCRIPTION OF DRAWINGS

The accompanying drawings are used to provide a further understanding of the present disclosure, constitute a part of the specification, and are used to explain the present disclosure together with the following specific embodiments, but should not he construed as limiting the present disclosure. In the drawings,

FIG. 1 is a schematic flowchart of a group communication method according to an embodiment of the present disclosure.

FIG. 2 is a schematic flowchart of a group communication method according to an embodiment of the present disclosure.

FIG. 3 is a schematic flowchart of a group communication method according to an embodiment of the present disclosure.

FIG. 4 is a schematic flowchart of a group communication method according to an embodiment of the present disclosure.

FIG. 5 is a schematic flowchart of a group communication method according to an embodiment of the present disclosure.

FIG. 6 is a schematic flowchart of a group communication method according to an embodiment of the present disclosure.

FIG. 7 is a schematic structural diagram of a first user device according to an embodiment of the present disclosure.

FIG. 8 is a schematic structural diagram of a second user device according to an embodiment of the present disclosure.

FIG. 9 is a schematic block diagram of a first user device according to an embodiment of the present disclosure.

FIG. 10 is a schematic block diagram of a second user device according to an embodiment of the present disclosure.

### DESCRIPTION OF EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Several terms that may be used herein are briefly explained before elaborating the present disclosure.

A user device, which may also be referred to as a terminal device, a terminal station or user equipment, may be any one of the following devices: a smartphone, a mobile phone, a cellular phone, a cordless phone, a session initiation protocol (SIP) phone, a wireless local loop (WLL) station, a personal digital assistant (PDA), a handheld device capable of wireless communication, an on-board equipment, a wearable device, a computing device or other processing devices connecting to a wireless modem.

In the group communication, a destination layer 2 (L2) ID identifies the target of the data in Sidelink proSe direct communication, and a group key is provisioned for each group to which user equipment (UE) belongs by the application layer, specifically by a group management server, in fact, the group key is shared by the group members for the conversion from the group ID to the destination L2 ID.

A group identifier (ID) is assumed to be associated. to both the data traffic and the control traffic. The group ID may change or may not change during the course of the group communication, which is not limited in the present disclosure. For facilitating the description, the group ID is assumed to remain unchanged during the course of the group communication, but the solutions may be slightly modified to be also applied to the case where the group ID changes, details will be illustrated in the following embodiments.

Further, for the data traffic from the application layer without the group ID associated, the V2X Layer treats it with legacy operations, i.e. using default Provider Service Identifier (PSID)/Intelligent Transport Systems (ITS)—Application Identifier (AID) mapping to determine a destination L2 ID. Besides, the unicast link/multicast group can be allocated with a flow identifier at the time of establishment. Corresponding connection profile information. e.g. L2 IDs, transmission settings, quality of service (QoS) parameters, etc., could be associated with it. In such a case, the upper layer only needs to use the flow identifier to indicate the destination and pass it down with the data packet. Further, when the application layer passes down the data packet that is associated with the group ID, the V2X layer tags the packet with the configured QoS settings (5G Quality of Service (QoS) Indicator (5QI for short) and Range) and passes those down to the AS Layer. The V2X layer also indicates to the AS Layer that it is for group communication, in order to differentiate it from broadcast traffic.

It should be noted that one of the possible application scenarios may be in the vehicle to everything (V2X) group communication, however, the V2X group communication is just used as an example here to describe the disclosure, but should not be construed as a limitation on the solutions provided in the disclosure. The solutions proposed in the disclosure may be applied in other scenarios where appropriate.

As mentioned in the foregoing part, no mechanism exists in related art for the conversion. However, if the group key is used for direct encryption of all elements, i.e. the entire data packet, including the L2 ID, the receiving UE will not know which group cast messages are meant for them and will have to decode all the encrypted messages increasing their computational cost. The receiving UE listens to the messages intended for it based on the destination L2 ID. If the destination L2 ID is encrypted, then all the messages received by the receiving UE will have to be decoded to find the intended message. Aiming at this problem, the embodiments of provide solutions where the group ID is converted into the destination L2 ID without increasing the computational cost of the UE.

Moreover, the conversion from the group ID to the destination L2 ID may be secured in terms of privacy and traceability. Unless the conversion is carefully performed, the group membership of specific user equipment (UE) could be disclosed. For example, attackers might be able to make an inquiry whether any member of certain group exists in some location. If the application layer group ID is not securely converted by the V2X layer, the intruder can link back to UE group memberships. The intruder may also tamper with the conversion process to produce fraudulent a destination layer-2 ID. Therefore, in some embodiments of the present disclosure, for the secure conversion of group ID provided by the application layer to the destination layer-2 ID, a hash function is introduced that is employed by the V2X layer to safely convert the application layer group ID to the destination Layer-2 ID. Besides, the group key is used to securely convert the ID. Details will be elaborated. hereafter with reference to the embodiments.

In the following, the embodiments of the present disclosure will be elaborated in details with reference to the accompanying figures.

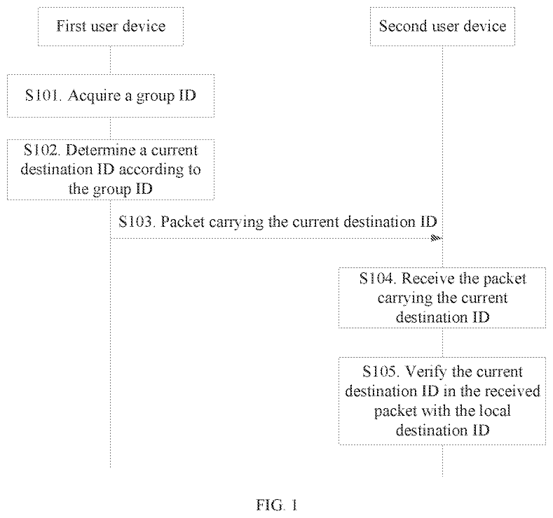

FIG. 1 is a schematic flowchart of a group communication method according to an embodiment of the present disclosure. The method may be executed by a first user device and a second user device. The method includes the following steps:

S101. A first user device acquires a group ID.

The group identifier is used for identifying a group including at least the first user device and a second user device. The group may include a plurality of user devices, and a same user device may be in different groups at the same time. Each group is identified by a group ID, which may change or may not change during the course of group communication. In the description, the first user device and the second user device are defined for illustrating the end to end group communication, and they may be any group members that respectively act as a transmitting user device and a receiving user device. The number of the group members is not limited in the embodiments of the present disclosure.

In a possible implementation, referring to the three-layer structure in the IoT, including an application layer, a V2X layer and an access stratum layer, the group ID may be provided by the application layer, and may also he referred to as a vertical application layer (VAL) group ID. The VAL group ID is a unique identifier within the VAL service that represents a set of VAL users or VAL UE according to the VAL service. The set of VAL users may belong to the same or different VAL service providers. It indicates the VAL application server where the group is defined.

In this step, the first user device acquires the group ID. In a possible implementation, the first user device receives the group ID from a third party. Here the third party may be, for example, a group management server. The group management server is responsible for the management of the group, and may distribute useful information to the group members, such as the group key for generating the destination L2 ID.

Besides, unless otherwise defined, the first user device may also be referred to as a transmitting UE, a transmitting user device, and the second user device may also be referred to as a receiving UE, a receiving user device.

S102. The first user device determines a current destination ID according to the group ID.

The current destination ID is used for identifying the second user device in the group. The first user device and the second user device use the current destination ID to perform the group communication. In a possible implementation, the current destination ID may be a destination layer 2 ID (L2 ID) in Sidelink prose direct communication, which identifies the target of the data in Sidelink prose direct communication. The destination L2 ID is 24 bits long and is split in the Media Access Control Address (MAC) layer into two bit strings. A first bit string is the least significant bit (LSB) part (8 bits) of the destination L2 ID and forwarded to physical layer as Sidelink control Laver-1 (L1) ID. This identifies the target of the intended data in Sidelink control and is used for filtering of packets at the physical layer. A second bit string is the most significant bit (MSB) part (16 bits) of the destination L2 ID and is carrier within the MAC header. This is used for filtering of packets at the MAC layer. The above provides only non-limiting examples of the IDs. It may be noted that IDs of different lengths may be possible as well. Similarly, distribution of the ID into the least and most significant parts may be done differently than explained above.

In the group communication, the L2 IDs, including the source L2 ID and the destination L2 ID), respectively identify the source and the target of the data packets of the group cast. If a same UE is a part of multiple groups, it will have a different L2 IDs for each group. The destination user L2 ID defines the target of data packet and in case of group communication, where the target is each UE in the group other than the transmitting UE. In conclusion, the source L2 ID represents individual UE for that link and the destination L2 ID represents each UE in the group cast communication.

There may be many possible implementations for determining the current destination ID by the first user device according to the group ID. In a possible implementation, the first user device acquires at least one parameter for determining the current destination ID, and determines the current destination ID according to the group ID and the at least one parameter.

Here the at least one parameter may be received by the first user device from a third party, which may be, a group management server. In some embodiments, the at least one parameter may include a group key. As mentioned in the foregoing part, the group key is provisioned for each group to which user equipment (UE) belongs, the group key can be provisioned using the mechanisms defined in TS 23.434. For example a key management server can provide the related security materials to the group management server that can be relayed to the members of the group. It also supports interactions with the corresponding key management server in distributed Service Enabler Architecture Layer for Verticals (SEAL) deployments. In some embodiments, the at least one parameter may not include a group key, instead, other parameters that may be used for the conversion of the group ID to the current destination ID may be employed, for example, a set of random numbers and a sequence for the set of random numbers. Detailed implementations for the determination may be elaborated with reference to the figures in the following embodiments.

S103. The first user device transmits to the second user device a packet carrying the current destination ID.

Once the current destination ID is determined, the first user device may transmit to the second user device a packet carrying the current destination ID. In a possible implementation, the packet is of the same structure as in related art, which will not be elaborated herein for brevity.

Taking the IoT for example, the lower layers cannot use the IDs of the upper layers, which makes the conversion of the upper layer ID, i.e., group ID to the lower layer ID, i.e., the destination L2 ID necessary. Therefore, the V2X layer at each user device may convert the group ID to the destination L2 ID, thus, the packet carrying the current destination ID herein may be an AS layer packet, which is transmitted in the AS layer between the first and second user devices.

Besides, the packet may he a data packet or a control packet, which is not limited herein.

S104. The second user device receives the packet carrying the current destination ID.

S105. The second user device verifies the current destination ID in the received packet with a local destination ID.

The second user device maintains a destination ID locally, which is referred to as the local destination ID here.

The second user device acquires a group ID and at least one parameter for determining the local destination ID, and then determines the local destination ID according to the group ID and the at least one parameter. Descriptions of the group ID and the at least one parameter may be as same as those in the foregoing steps on the first user device side, which will not be repeated herein for brevity.

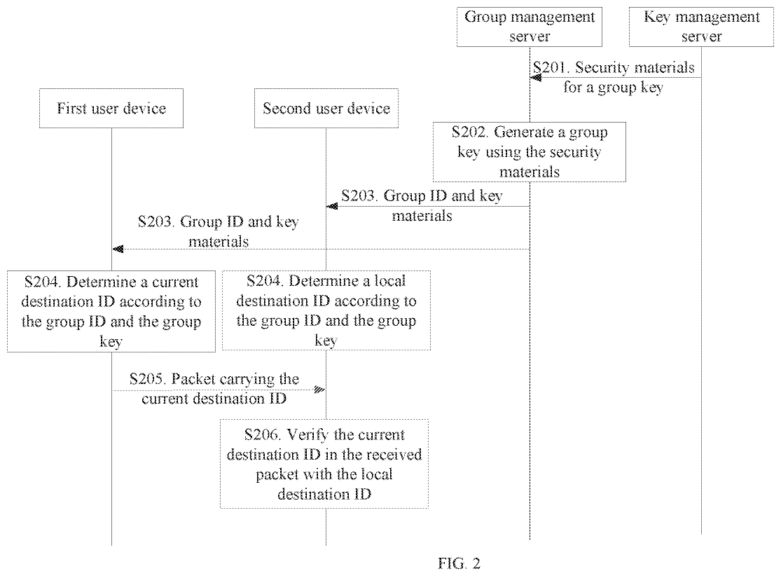

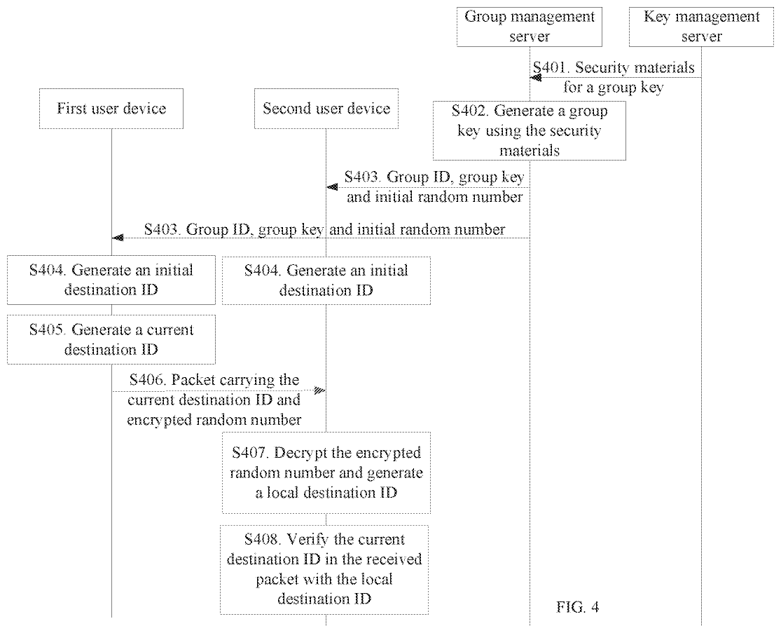

The local destination ID is used for verification performed by the second user device, and may be determined by the second user device before the receiving of the packet or after that. In a possible implementation, the receiving user device, that is the second user device, needs some parameter from the first user device for the determination of the local destination ID (for example, the embodiment illustrated with reference to FIG. 4), then the parameter may be carried along with the current destination ID in the packet, and the determination of the local destination ID may be after the receiving of the packet, in this case, the structure of the packet would be of a different structure than that in related art. In another possible implementation, the second user device may determine the local destination ID at his side without any information from the first user device (for example, the embodiments illustrated with reference to FIGS. 2, 3 and 5). Details may be discussed in the following embodiments.

The verification is actually performed by the second user device to verify the accuracy of the conversion of the destination ID. In a possible implementation, the second user device may compare the current destination ID in the received packet with the local destination ID, if it is the same, then the second user device may start to monitor a packet using the current destination ID. In other words, the verification is just for making sure that the destination ID calculated by the second user device is the same as the one sent by the first user device.

According to the solution provided by the present disclosure, the application layer group ID will be converted to the destination L2 ID, thus enabling the end to end group communication.

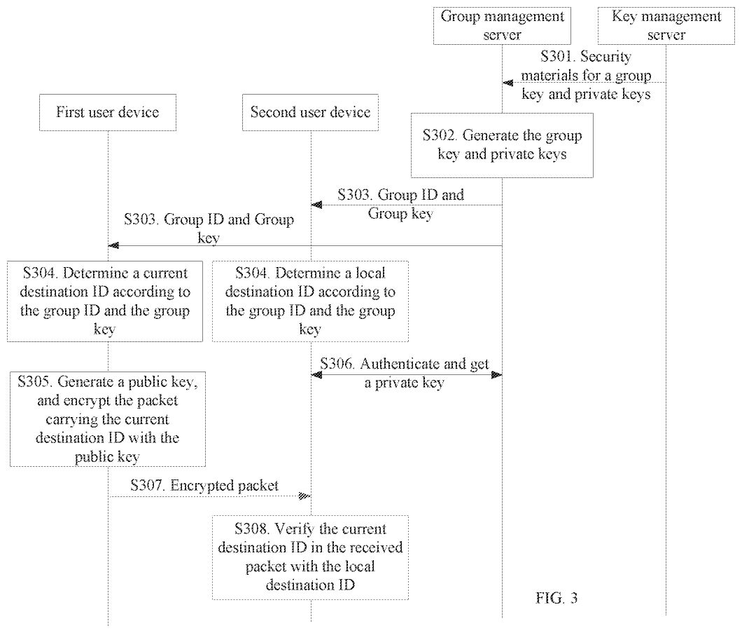

As mentioned in the above part, the conversion from the group ID to the destination ID may be performed using the at least one parameter, which may be a group key. In the following, the embodiments will be elaborated with reference to FIGS. 2-3, where the group key is employed for the conversion. In these embodiments, the second user device determines its local destination ID by itself without any information from the first user device, and both of the current destination ID generated by the first user device and the local destination ID generated by the second user device may remain unchanged during the course of the group communication. In the following, descriptions are made on assuming that the group ID remains unchanged during the course of the group communication. In the case where the group ID changes in the course of the group communication, the destination ID converted from the group ID also changes, and each time the group ID changes, the same procedure applies to convert the group ID into the destination ID, which will not be repeated hereafter for brevity.

FIG. 2 is a schematic flowchart of a group communication method according to an embodiment of the present disclosure. According to this embodiment, using the example of IoT, the transmitting UE uses the provisioned group key directly to generate the L2 ID. As all the UEs in the group have the group key, the same mechanism is followed by them all to get the L2 IDs. Referring to the IoT, the V2X layer at each user device (or UE) uses the provisioned group key to convert the group Identifier to the destination L2 ID.

The method may include the following steps:

S201. A key management server transmits security materials for generating a group key, and a group management server receives the security materials from the key management server.

On considering the privacy and security of the group key, a key management server may provide the security materials to the group management server for the generation of the group key.

S202. The group management server generates a group key using the security materials.

Upon receiving the security materials, the group management server may generate the group key. The specific manner for the generation is not limited here in the embodiments of the present disclosure.

S203. The group management server transmits a group ID and key materials to the first user device and a second user device, and the first user device and the second user device receive the group ID and the key materials from the group management server respectively.

In a possible implementation, as shown in FIG. 2, the group management server may send key materials to the first and second user devices, so that the two user devices may generate the keys used for the conversion by themselves. In this case, the group management server no longer needs to generate the group key in step S202. Similarly, in the other embodiments, the group management server may also send the key materials instead of the group key, which is not limited by the embodiments of the present disclosure.

In another possible implementation, the group management server may generate the group key, and transmits the group key to the first and the second user devices.

The group management server transmits the group ID as well as the key materials to both of the first and second user devices, so that they could generate the destination IDs by themselves.

S204. The first user device determines a current destination ID according to the group ID and the group key, and the second user device determines a local destination ID according to the group ID and the group key.

The first user device may determine the current destination ID in many ways. In a possible implementation, the first user device generates the current destination ID based on the group ID using the group key and a predefined algorithm. Here the predefined algorithm is not limited here in the embodiments. In another possible implementation, the conversion of the group ID to the destination L2 ID can be done in many ways, for example the encrypted value of the group ID can directly be used as the destination L2 ID depending on the length of L2 ID. The encryption methods used in TS 33.501 can be employed.

The second user device may determine the local destination ID in the same way as the generation of the current destination ID by the first user device. For example, based on the group ID using the at least one parameter and the predefined algorithm.

S205. The first user device transmits to the second user device a packet carrying the current destination ID, and the second user device receives the packet carrying a current destination ID.

Once the current destination ID is determined, the first user device may transmit to the second user device a packet carrying the current destination ID. In a possible implementation, the packet is of the same structure as in related art, which will not be elaborated herein for brevity.

In this embodiment, the second user device generates the local destination ID by itself, that is, not depending on any information from the first user device, so the determination of the local destination ID may be independent from the receiving of the packet from the first user device.

S206. The second user device verities the current destination ID in the received packet with the local destination ID.

Reference may be made to related descriptions in step S105 for this step.

It should be noted that the key management server and the group management server in the embodiments of the present disclosure are all for illustration purpose, and should not be construed as limitations to the present disclosure. Other similar devices may be used instead of these servers as long as they could function in the same way as described in the embodiments.

According to the solution provided by the present disclosure, the group key is employed for converting the application layer group ID into the destination L2 ID, thus enabling the end to end group communication.

FIG. 3 is a schematic flowchart of a group communication method according to an embodiment of the present disclosure. According to this embodiment, using the example of IoT, asymmetric ID based encryption is used for the conversion, so as to secure the conversion of the destination L2 ID. Identity-based systems allow any party to generate a public key from a known identity value (application layer group ID in this case, i.e., the group ID). A trusted third party, group management server in this case, creates the corresponding private keys. First, the group management server publishes a master public key, and retains the corresponding master private key. Using this master public key, any user device can compute a public key corresponding to the group ID by combining the master public key with the group ID value. To obtain a corresponding private key, the UEs are authorized to use the group ID to contact with the group management server, which uses the master private key to generate the private key for the group ID. Then both parties (for example, the transmitting user device and the receiving user device) can encrypt their messages.

The method includes the following steps:

S301. A key management server transmits security materials for generating a group key and a private key, and a group management server receives the security materials from the key management server.

On considering the privacy and security of the group key, a key management server may provide the security materials to the group management server for the generation of the group key, as well as for the generation of the private key for both of the first user device and the second user device. Reference may be made to TS 23.434 for the security materials for the master private key (the private key corresponding to the group ID in this embodiment) and the master public key (the group key) generation to be provided by the key management server.

S302. The group management server generates a group key and private keys using the security materials.

Upon receiving the security materials, the group management server may generate the group key and the private keys for both of the first and second user devices. The specific mariner for the generation is not limited here in the embodiments of the present disclosure.

The group management server uses the group key as the master public key and sends it to the UEs that are members of the group (for example, the first user device and the second user device), and generates a master private key and retains it.

S303. The group management server transmits a group ID and the group key to the first user device and the second user device, and the first user device and the second user device receive the group ID and the group key from the group management server respectively.

Reference may be made to related descriptions in step S203 for this step.

S304. The first user device determines a current destination ID according to the group ID and the group key, and the second user device determines a current destination ID according to the group ID and the group key.

Reference may be made to related descriptions in step S204 for this step.

S305. The first user device generates a public key using the group ID and the group key, and encrypts the packet carrying the current destination ID with the public key.

The transmitting UE, that is the first user device, calculates the public key for the receiving UE, that is the second user device, using the group ID and the master public key. The receiving UE calculates the public key for the transmitting UE a similar manner (which is not shown in the figure). The destination L2 ID is calculated using the master public key is done as well by all the UEs in the group.

Various algorithms of ID-based encryption can be employed, such as Boneh-Franklin, Sakai-Kasahara, Boneh-Boyen etc. The selection of these methods is not limited by the embodiments of the present disclosure.

S306. The second user device authenticates with the group management server and gets a private key.

In this step, the receiving UE, or the second user device uses the group ID to perform the authentication, and receives the private key from the group management server. The private key corresponds to the public key generated by the first user device based on the group ID and the group key. All the UEs get authenticated by the group management server and receive their corresponding private keys. It should be noted that the authentication is likely to be done by the application layer when the group is being created. So it can be skipped and the private keys can be obtained directly. Otherwise, the authentication methods in TS 33.501 can be used.

S307. The first user device transmits the encrypted packet to the second user device, and the second user device receives the encrypted packet carrying the current destination ID.

The data packets are then encrypted using the public key by the transmitting UE, i.e., the first user device.

S308. The second user device verifies the current destination ID in the received packet with the local destination ID.

Upon receiving the packet, the second user device may obtain the destination L2 ID using the corresponding private key which is received from the group management server.

The second user device decrypts the packet carrying the current destination ID using the private key, and compares the current destination ID in the decrypted packet with the local destination ID. Reference may be made to related descriptions in step S105 for the verification.

According to the solution provided by the present disclosure, the asymmetric ID based encryption is used for converting the application layer group ID into the destination L2 ID, thus enabling the end to end group communication as well as ensuring the security of the communication.

In the foregoing embodiments illustrated with reference to FIGS. 2 and 3, the conversion of the group ID to the destination ID is performed once, which enables the end to end group communication between group members. As mentioned above, the present disclosure also provides solutions for further securing the conversion. In general, different from the foregoing embodiments, in the embodiments which will be illustrated with reference to FIGS. 4 and 5, the destination ID is converted multiple times rather than once during the group communication. Same as for the foregoing embodiments, in the case where the group ID changes in the course of the group communication, the destination ID converted from the group ID also changes, each time the same procedure applies and details are omitted for brevity. In the case where the group ID remains unchanged in the course of the group communication, the group ID may also be converted multiple times into different destination IDs so as to avoid attacks from intruders. In the following, detailed description will be made with reference to FIGS. 4 and 5.

When the group ID is converted multiple times, it is necessary for the first user device to determine a triggering condition for each conversion. In a possible implementation, the first user device may first determine whether a triggering condition is satisfied before implementing the conversion, and in response to determining that the triggering condition is satisfied, the first user device generates the current destination ID according to the group ID and the group key, otherwise, in response to determining that the triggering condition is not satisfied, the first user device determines a previously generated destination ID as the current destination ID.

Three specific solutions will be elaborated in the following embodiments. In the first two solutions related to FIG. 4, at first, the first user device and the second user device both receive the group ID from the group management server, and one UE (for example, the first user device) will be selected as a group leader once the members of the group receive the corresponding group ID, in the first conversion, since there is no destination ID between the two user devices, therefore, an initial destination ID will be generated by both of the first and second user devices based on the group key and an initial random number from the group management server. Then, once the initial destination ID is generated, both user devices may use this initial destination ID to communicate with each other, hence, in the second conversion, the first user device, which is selected as the group leader, will generate a random number (if necessary), and the second user device may generate its local destination ID based on the random number from the first user device. In the consecutive conversions, the same procedure as the second conversion applies. Hence, the first user device may judge the triggering condition after the first conversion, and also between each two consecutive conversions. The triggering condition for initiating the second conversion may be the same as or different from that for triggering the subsequent conversions after the second conversion.

In the solution related to FIG. 5, different from the first two solutions related to FIG. 4, the second user device may generate its local destination ID without any information from the first user device. In this case, the first user device may judge the triggering condition between each two conversions, that is to say, after each conversion, the first user device may determine whether the triggering condition is satisfied and decide whether to generate a new destination ID or to keep using the previously generated one (or an old destination ID).

Now referring to FIG. 4, which is a schematic flowchart of a group communication method according to an embodiment of the present disclosure. According to this embodiment, using the example of Iot, the transmitting UE generates a random number and uses a hash function to calculate the destination L2 ID from the group ID provided by the application layer. The random number is encrypted using a group key which is provisioned to all the UEs belonging to the group and sent to all the UEs. The receiving UEs decrypt the random number and use it to calculate the corresponding destination L2 ID. The number of times the L2 ID is changed before the application layer changes the group ID is up to implementations. Once the members of the group receive the corresponding group ID, one UE is selected as the group leader by the group management server. That UE serves as the initiator for the second ID conversion.

The method may include the following steps:

S401. A key management server transmits security materials for generating a group key, and a group management server receives the security materials from the key management server.

Reference may be made to related descriptions in step S201 for this step.

S402. The group management server generates a group key using the security materials.

Reference may be made to related descriptions in step S202 for this step.

In addition to the group key, the group management server may also generate an initial random number for the first conversion, this initial number will be used by both of the first and second user devices to generate an initial destination ID. In another possible implementation, the group management server may send information for generating the initial random number to both user devices, so that the user devices may generate the initial random number by themselves. For example, the group management server can send the corresponding materials to generate the initial random number rather than sending the initial random number itself to reduce the computational cost. Using the received materials all the UEs generate the same initial number. This is assuming that all the UEs have the same random number generator. Reference may be made to TS 33.501 for the random number generator.

S403. The group management server transmits a group ID, an initial random number and the group key to the first user device and the second user device, and the first user device and the second user device receive the group ID and the group key from the group management server respectively.

For the first conversion, which may be triggered by creation of group or change in the group ID from the application layer, the group management server provides each UE with the group ID, the initial random number RAND0 and the group key.

S404. The first user device generates an initial destination ID based on the group ID using the hash function and the initial random number, and the second user device generates the initial destination ID based on the group ID using the hash function and the initial random number.

As mentioned above, since there is no destination ID for implementing the group communication when the group is created, an initial destination ID is generated by all group members based on the group ID, the initial random number and the group key from the group management server. In this way, after the first conversion, that is the conversion from the group ID to an initial destination ID, the user devices may use this converted initial destination ID to communicate with each other.

Each user device uses the initial random number RAND0 and the group ID as inputs to a hash function to obtain the destination L2 ID simultaneously as follows:

Hash (Group ID, RAND0)=Destination L2 ID.

As mentioned in the foregoing embodiment, the destination L2 ID may be of different lengths, hence the implementation of the hash function can be varied according to the length of the destination L2 ID and the group ID, For example SHA-256 hash function can take Group Identifier and RAND 0 as its inputs and output a unique 256 bit long destination L2 ID.

S405. The first user device generates a current destination ID based on the group ID using the hash function and a determined random number.

As discussed in the foregoing part, after the first conversion, when the triggering condition is satisfied, the first user device, which is selected as the initiator, may initiate the second conversion. The triggering of the destination L2 ID conversion by the initiator can be based on an internal timer at the initiator (the first user device). For example the time to change the source L2 ID can be used to change the destination L2 ID for the group communication as well. Or the triggering condition is that a time period starting from a time at which the previously generated destination ID is generated exceeds a second predefined time period, for example, the group management server can send a timer T (which expires after the second predefined time period) to that initiator, so that the initiator can use this timer T to initiate the second conversion.

Once the triggering condition is satisfied, the first user device may determine a random number, and generate the current destination ID based on the group ID using the hash function and the determined random number. Since the current destination ID here is generated in the second conversion, the initial destination ID may be regarded as a previously generated destination ID.

S406. The first user device encrypts the random number with the group key, transmits to the second user device a packet carrying the current destination ID and the encrypted random number, and the second user device receives the packet carrying the current destination ID and the encrypted random number.

The group key provisioned to the members of the group is used to encrypt the random number. The AS layer at the first user device transmits the encrypted random number and the current destination L2 ID in the data packet. The encrypted random number may be added either as prefix or appended to the data packet and it does not alter the data packet.

The random number can be encrypted either directly by the group key or by derivation of separate integrity and confidentiality related keys by using mechanisms as mention in TS 33.303.

The first and second user devices use the initial destination ID generated in step S404 for communication while transmitting and receiving the encrypted random number and the current destination ID generated in step S405.

S407. The second user device decrypts the encrypted random number with the group key, and generates a local destination ID based on the group ID using a hash function and the decrypted random number.

At the receiving side, the group key is used to decrypt the random number sent from the first user device. The V2X layer at the second user device uses the received random number and the same hash function as mentioned in step S405 to calculate the local destination ID from the group ID.

S408. The second user device verifies the current destination ID in the received packet with the local destination ID.

When the second user device has calculated the local destination ID and verified that it is the same as sent by the first user device, then it can start using the new ID, i.e., the current destination ID.

In the foregoing steps, descriptions are made to explain the first conversion and the second conversion, for the consecutive conversions after the second conversion, a random number RANDi (i=1 to n, where n is the number of times the L2 ID is converted before the group ID changes) (which may a number of 256 bits for example) is generated by the first user device (the initiator user device) each time when a triggering condition is satisfied. Then the same procedure as described in steps S405-S408 applies for the first and second user devices. Referring to the IoT for example, the V2X layer at the first user device uses the hash function and the random number RANDi to convert the application layer group ID into a new destination L2 ID. As mentioned above, the triggering condition for these consecutive conversions may be the same as the triggering condition for the second conversion, that is, each conversion after the second conversion can be based on an internal timer at the initiator (the first user device). For example the group management server can send a timer T to that initiator (the first user device), so that the first user device can use this timer T to start the next conversion.

The group ID is converted to a new L2 ID multiple times during the validity of application layer group ID, in both cases if the application layer group ID is changed during the course of group communication or not. The encrypted random number is sent along every time the conversion is performed. It should be noted that the lifetime, or the expiring time of the destination ID is shorter than the expiring time of the group ID.

Moreover, as a possible implementation, in order to further secure the conversion, the random number may be generated and transmitted arbitrarily, which may be referred to as an ON/OFF mode of the random number. That is, the random number is generated sometimes and the encrypted value is added in the packet transmitted from the first user device to the second user device. Sometimes the random number may not be generated and no encrypted value is added in said packet. For example, before each conversion, when the first user device decides that the triggering condition is satisfied (such as the timer T expires), which means a next conversion needs to be performed. In this case, the first user device may directly generate a random number and go on with the procedure, as done in step S405, or, it may determine whether to generate the random number first according to a generating condition and then determine the random number to be used for the conversion. That is, the first user device determines whether a generating condition for generating, the random number is satisfied, in response to determining that the generating condition is satisfied, the first user device generates the random number, and in response to determining that the generating condition is not satisfied, the first user device uses the previously generated random number as the random number.

In a possible implementation, the generating condition here may be that a lifetime for a previously generated random number exceeds a first predefined time period. It should be noted that the lifetime, or the expiring time of the random number is shorter than the expiring time of the destination ID.

when the time period starting from the generation of the previously generated random number exceeds the first predefined time period, the first user device decides to generate a new random number, in this case, the newly generated random number may be used in the conversion of the current destination ID in step S405, and in step S406, the newly generated random number needs to be encrypted and transmitted in the packet;

when the time period starting from the generation of the previously generated random number does not exceed the first predefined time period, the first user device decides not to generate a new random number, in this case, the previously generated random number is used for performing the conversion, which will come to the same result as the former conversion, therefore, the first user device may directly use the previously generated destination ID. In this case, there is no need to encrypt and transmit the random number in the packet.

In another possible implementation, the generating condition here may be that a flag in a predefined pattern is true. The frequency of sending or not sending the encrypted random number may be up to implementation. For example, the random number can be generated by following a predefined pattern: 1,1,0,0,1,0,0 . . . (where a flag 1 represents that the random number is generated and a flag 0 represents it's not). This pattern can be provisioned by the application layer as well.

On the receiving side, the second user device determines whether there exists an encrypted random number in the received packet, in response to determining that there exists an encrypted random number in the received packet, the second user device decrypts the encrypted random number and generates the local destination ID based on the group ID using a hash function and the decrypted random number; and in response to determining that there does not exist an encrypted random number in the received packet, the second user device determines a previously generated local destination ID as the local destination ID, that is, the second user device keeps using the previously generated local destination ID.

In sum, the ON/OFF mode, the procedure is similar to those shown in FIG. 4, except after the first conversion, the random number is generated and sent with encryption in some cases and not in other cases. The decision is made arbitrarily.

According to the solution provided by the present disclosure, the conversion of the destination ID may be performed multiple times, thus ensuring that the application layer group ID will be securely converted to the destination L2 ID and this conversion process cannot be tampered by an adversary. The adversary will not be able to link the destination L2 ID to the UE group membership thereby protecting the integrity and privacy of the member UE. The UE only decrypts the messages or listens to the messages intended for it as the destination L2 ID is not encrypted, thus reducing the computational expense and hence delay as well (although this may not apply to the first conversion process, but the subsequent conversion can benefit). Besides, the arbitrarily transmitting of the random number further secures the conversion process.

In the foregoing embodiment described with reference to FIG. 4, the second user device needs to calculate its local destination ID based on information (such as the encrypted random number) from the first user device. In the following embodiment, the second user device may generate its local destination ID without any information from the first user device.

FIG. 5 is a schematic flowchart of a group communication method according to an embodiment of the present disclosure. According to this embodiment, using the example of IoT, the group management server sends a set of random numbers to all the user devices and a timer value (time interval) and a set of sequence for the random numbers. The user devices calculate the destination L2 ID from the group ID using the random number according to the sequence number.

The method may include the following steps:

S501. A group management server transmits a group ID, an time interval, a set of random numbers and a sequence for the set of random numbers to a first user device and a second user device, and the first user device and the second user device receive the group ID, the se of random numbers and the sequence for the set of random numbers from the group management server respectively.

Once the group is created, the group management server will send the group ID to the associated user devices. It will also send a set of random number and a sequence for the set of random numbers, which is a specific sequence in which these random numbers are to be used. A time interval is also sent.

It should be noted that the length of the set of random numbers is up to the implementation. For example whether the set has 10 random numbers or 100 random numbers depends on how frequently the destination ID is to be updated.

The group management server can also send the corresponding materials to generate the set of random numbers rather than sending the set of random numbers itself to reduce the computational cost. Using the received materials all the user devices generate the same set of random numbers in the same sequence. This is assuming that all the UEs have the same random number generator. Reference may be made to TS 33.501 for the random number generator.

S502. The first user device generates an old destination ID according to the group ID, the set of random numbers and the sequence for the set of random numbers, and the second user device generates an old local destination ID according to the group ID, the set of random numbers and the sequence for the set of random numbers.

The first user device may select a random number from the set of random numbers according to the sequence for the set of random numbers, and generates the old destination ID (a previously generated destination ID) based on the group ID using a hash function and the selected random number.

For example, for the first conversion, the first user device uses the group ID and the first random number according to the sequence as an input to a hash function to generate the old destination ID.

Hash (Group Identifier, RAND1)=Old destination ID.

Here the RAND1 represents the first random number in the set according to the sequence. For the consecutive conversions, for example, if the sequence number in the sequence for the set of random numbers says 7, the first user device uses the 7-th random number to generate the destination ID.

At the receiving side, the second user device performs similar operations as the first user device to get the old local destination ID. After each update the second user device listens to both old and new destination IDs until it receives a message from the new destination ID from the transmitting user device.

S503. The first user device transmits to the second user device a packet carrying the old destination ID, and the second user device receives the packet carrying the old destination ID.

S504. The second user device verifies the old destination ID in the received packet with the old local destination ID.

Reference may be made to related descriptions in step S105 for this step.

S505. When the time interval expires, the first user device generates a new destination ID according to the group ID, the set of random numbers and the sequence for the set of random numbers, and the second user device generates a new local destination ID according to the group ID, the set of random numbers and the sequence for the set of random numbers.

When the time interval expires, a new destination ID is calculated using the next random number according to the sequence. That is, when the time interval expires, the first user device calculates the new destination ID using the next random number in the sequence.

Hash (Group identifier, RAND2)=New destination ID.

Here the RAND2 represents the second random number in the set according to the sequence.

S506. The first user device transmits to the second user device a packet carrying the new destination ID, and the second user device receives the packet carrying the new destination ID.

S507. The second user device verifies the new destination ID in the received packet with the new local destination ID.

In a case where the current destination ID in the received packet is as same as the local destination ID, the second user device starts to monitor a packet using the current destination ID. In fact, in order to ensure time synchronization issues, the second user device starts listening to both old and new destination IDs, The second user device can stop listening to the old destination ID as soon as it receives the message from the new destination ID.

The destination L2 ID is updated every time the time interval expires until the application layer triggers the change of the group ID.

In this embodiment, the destination ID is updated once for illustration purpose. In actual applications, each update of the destination ID may be as same as the procedure described herein, which will not be repeated again for brevity.

According to the solution provided by the present disclosure, the conversion of the destination ID may be performed multiple times, thus ensuring that the application layer group ID will be securely converted to the destination L2 ID and this conversion process cannot be tampered by an adversary. The adversary will not be able to link the destination L2 ID to the UE group membership thereby protecting the integrity and privacy of the member UE. The UE only decrypts the messages or listens to the messages intended for it as the destination L2 ID is not encrypted, thus reducing the computational expense and hence delay as well.

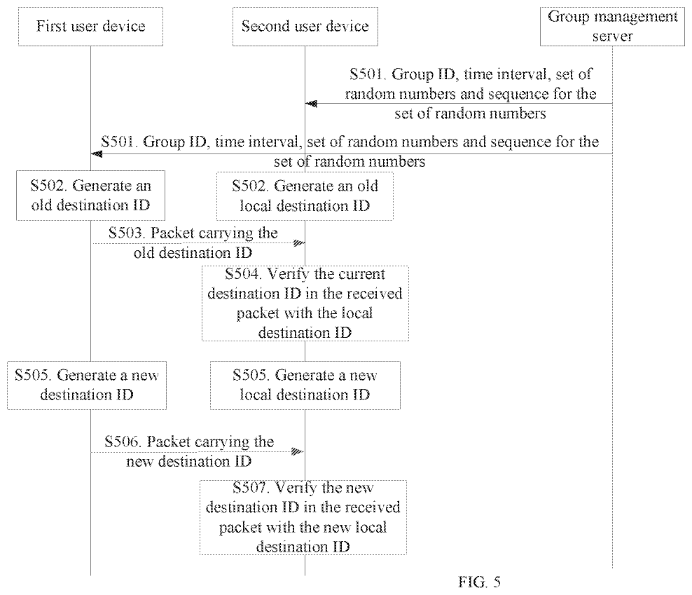

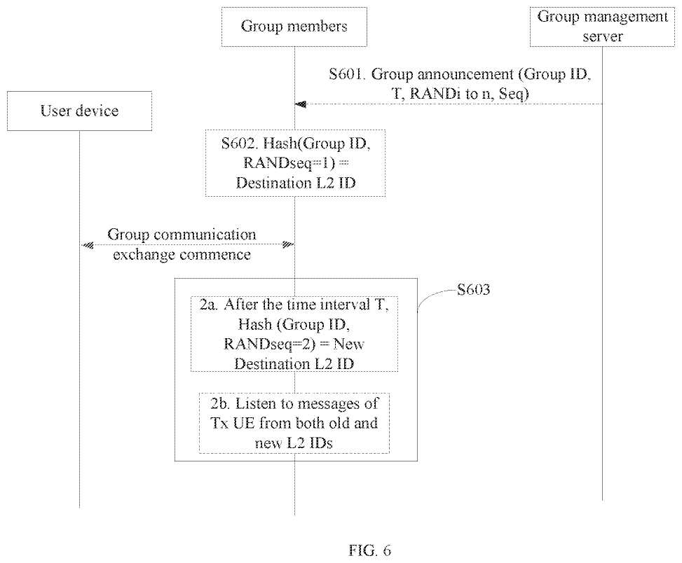

FIG. 6 is a schematic flowchart of a group communication method according to an embodiment of the present disclosure. It actually corresponds to the solution shown in FIG. 5 but with more details. It shows a procedure for secure conversion of an application layer group ID to a destination L2 ID.

S601. Group Setup: Once the group is created, the group management server will send the group ID to the associated UEs and a timer T. It will also send a set of random numbers and a specific sequence in which these random numbers are to be used. It is assumed that the application layer signalling is protected.

S602. ID Conversion: All the UEs use the group ID and the first random number according to the sequence as an input to a hash function to generate the destination L2 ID.

S603. ID Update: when the timer T expires, a new destination L2 ID is calculated using the next random number according to the sequence. The UEs can listen to both old a new destination L2 IDs, to avoid any time synchronization issues, for a certain period of time or until receives a message with the new destination ID.

The destination L2 ID is updated until the application layer changes the group ID.

The group management server can also send the corresponding materials to generate random numbers rather than sending the random numbers themselves.

FIG. 7 is a schematic structural diagram of a first user device according to an embodiment of the present disclosure. The first user device 700 includes an acquiring module 701, a determining module 702 and a transmitting module 703.

The acquiring module 701, configured to acquire a group identifier (ID), where the group identifier is used for identifying a group including at least the first user device and a second user device; the determining module 702, configured to determine a current destination ID according to the group ID, where the current destination ID is used for identifying the second user device in the group; and the transmitting module 703, configured to transmit to the second user device a packet carrying the current destination ID.

In a possible implementation, the determining module 702 is specifically configured to:

acquire at least one parameter for determining the current destination ID; and

determine the current destination ID according to the group ID and the at least one parameter.

In a possible implementation, the determining module 702 is specifically configured to:

determine whether a triggering condition is satisfied;

in response to determining that the triggering condition is satisfied, generate the current destination ID according to the group ID and the at least one parameter; and

in response to determining that the triggering condition is not satisfied, determine a previously generated destination ID as the current destination ID.

In a possible implementation, the determining module 702 is specifically configured to:

determine a random number; and

generate the current destination ID based on the group ID using a hash function and the random number.

In a possible implementation, the determining module 702 is specifically configured to:

determine whether a generating condition for generating the random number is satisfied;

in response to determining that the generating condition is satisfied, generate the random number; and

in response to determining that the generating condition is not satisfied, use the previously generated random number as the random number.

In a possible implementation, the transmitting module 703 is specifically configured to:

in response to determining that the generating condition is satisfied, encrypt the random number with the at least one parameter; and transmit to the second user device a packet carrying the current destination ID and the encrypted random number.

In a possible implementation, the transmitting module 703 is specifically configured to:

in response to determining that the generating condition is not satisfied, transmit to the second user device a packet carrying the current destination ID.

In a possible implementation, the generating condition is that a lifetime for a. previously generated random number exceeds a first predefined time period, or a flag in a predefined pattern is true.

In a possible implementation, the previously generated destination ID is generated by the first user device based on the group ID using the hash function and an initial random number.

In a possible implementation, the initial random number is received by the first user device from a third party or generated by the first user device based on information from the third party.

In a possible implementation, the determining module 702 is specifically configured to:

generate the current destination ID based on the group ID using the at least one parameter and a predefined algorithm.

In a possible implementation, the transmitting module 703 is specifically configured to:

generate a public key using the group ID and the at least one parameter;

encrypt the packet carrying the current destination ID with the public key; and

transmit the encrypted packet to the second user device.

In a possible implementation, the at least one parameter includes a set of random numbers and a sequence for the set of random numbers;

where the determining module 702 is specifically configured to:

select a random number from the set of random numbers according to the sequence for the set of random numbers; and

generate the current destination ID based on the group ID using a hash function and the selected random number.

In a possible implementation, the at least one parameter includes a group key.

In a possible implementation, the triggering condition is that a time period starting from a time at which the previously generated destination ID is generated exceeds a second predefined time period.

In a possible implementation, the acquiring module 701 is specifically configured to:

receive the at least one parameter from a third party.

In a possible implementation, the acquiring module 701 is specifically configured to:

receive the group ID from a third party.

In a possible implementation, the third party is a group management server.

In a possible implementation, the packet carrying the current destination ID is a packet of an access stratum (AS) layer.

In a possible implementation, the current destination ID is a destination layer 2 ID (L2 ID) in Sidelink prose direct communication.

In a possible implementation, the packet is a data packet or a control packet.

In a possible implementation, the group ID is a vertical application layer ID.

According to the solution provided by the present disclosure, the conversion of the destination ID may be performed multiple times, thus ensuring that the application layer group ID will be securely converted to the destination L2 ID and this conversion process cannot be tampered by an adversary. The adversary will not be able to link the destination L2 ID to the UE group membership thereby protecting the integrity and privacy of the member UE. The UE only decrypts the messages or listens to the messages intended for it as the destination L2 ID is not encrypted, thus reducing the computational expense and hence delay as well.

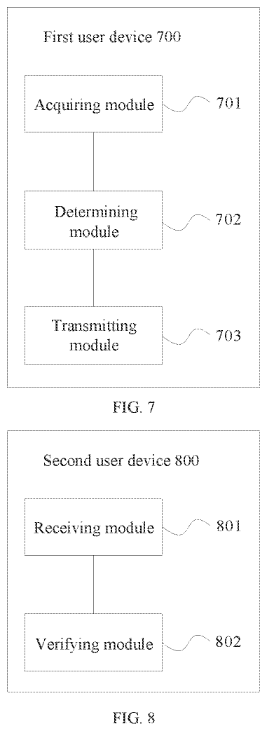

FIG. 8 is a schematic structural diagram of a second user device according to an embodiment of the present disclosure. The second user device 800 includes a receiving module 801 and a verifying module 802.

The receiving module 801, configured to receive a packet carrying a current destination identifier (ID), where the current destination ID is used for identifying the second user device in a group, and the group includes at least a first user device and the second user device; and the verifying module 802, configured to verify the current destination ID in the received packet with a local destination ID.

In a possible implementation, the second user device further includes:

an acquiring module, configured to acquire a group ID, where the group ID is used for identifying the group, and acquire at least one parameter for determining the local destination ID; and

a determining module, configured to determine the local destination ID according to the group ID and the at least one parameter.

In a possible implementation, the determining module is specifically configured to:

determine whether there exists an encrypted random number in the received packet;

in response to determining that there exists an encrypted random number in the received packet, decrypt the encrypted random number with the at least one parameter, and generate the local destination ID based on the group ID using a hash function and the decrypted random number; and

in response to determining that there does not exist an encrypted random number in the received packet, determine a previously generated local destination ID as the local destination ID.

In a possible implementation, the determining module is specifically configured to:

generate the local destination ID based on the group ID using the at least one parameter and a predefined algorithm.

In a possible implementation, the verifying module 802 is specifically configured to:

obtain a private key, where the private key corresponds to a public key generated by the first user device based on the group ID and the at least one parameter;

decrypt the packet carrying the current destination ID using the private key; and

compare the current destination ID in the decrypted packet with the local destination ID.

In a possible implementation, the at least one parameter includes a set of random numbers and a sequence for the set of random numbers;

where the determining module is specifically configured to:

select a random number from the set of random numbers according to the sequence for the set of random numbers; and

generate the local destination ID based on the group ID using a hash function and the selected random number.

In a possible implementation, the second user device further includes a monitoring module configured to:

in a case where the current destination ID in the received packet is as same as the local destination ID, start to monitor a packet using the current destination ID.

According to the solution provided by the present disclosure, the conversion of the destination ID may be performed multiple times, thus ensuring that the application layer group ID will be securely converted to the destination L2 ID and this conversion process cannot be tampered by an adversary. The adversary will not be able to link the destination L2 ID to the UE group membership thereby protecting the integrity and privacy of the member UE. The UE only decrypts the messages or listens to the messages intended for it as the destination L2 ID is not encrypted, thus reducing the computational expense and hence delay as well.

As shown in FIG. 9, an embodiment of the present disclosure further provides a first user device 900. The device 900 may be the device 700 in FIG. 7, which can be configured to implement content pertaining to the first device corresponding to the method in the method embodiments. The device 900 includes an input interface 910, an output interface 920, a processor 930, and a memory 940. The input interface 810, the output interface 920, the processor 930, and the memory 940 can be connected by a bus system. The memory 940 is configured to store programs, instructions or codes. The processor 930 is configured to execute the programs, the instructions or the codes in the memory 940 to control the input interface 910 to receive a signal and control the output interface 920 to transmit a signal and complete the operations in the foregoing method embodiments.

In a specific implementation, the transmitting module 703 in the device 700 shown in FIG. 7 may be implemented with the output interface 920 in FIG. 9, also, the acquiring module 701 and the determining module 702 in the device 700 shown in FIG. 7 may be implemented with the processor 930 in FIG. 9.

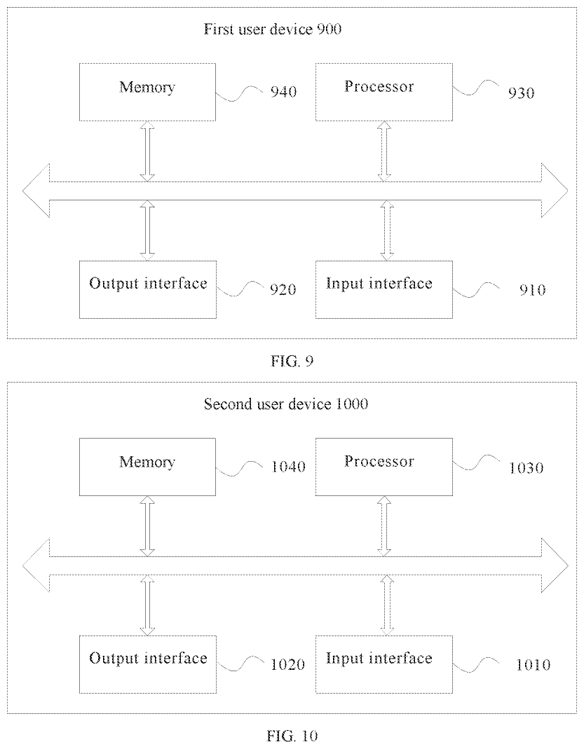

As shown in FIG. 10, an embodiment of the present disclosure further provides a second user device 1000. The device 1000 may be the device 800 in FIG. 8, which can be configured to implement content pertaining to the first device corresponding to the method in the method embodiments. The device 1000 includes an input interface 1010, an output interface 1020, a processor 1030, and a memory 1040. The input interface 1010, the output interface 1020, the processor 1030, and the memory 1040 can be connected by a bus system. The memory 1040 is configured to store programs, instructions or codes. The processor 1030 is configured to execute the programs, the instructions or the codes in the memory 1040 to control the input interface 1010 to receive a signal and control the output interface 1020 to transmit a signal and complete the operations in the foregoing method embodiments.

In a specific implementation, the receiving module 801 in the device 800 shown in FIG. 8 may be implemented with the output interface 1020 in FIG. 10, also, the verifying module 802 in the device 800 shown in FIG. 8 may be implemented with the processor 1030 in FIG. 10.

The present disclosure also provides a computer storage medium storing computer executable instructions which, when being executed, implement the method according to the embodiments of the present disclosure.

The present disclosure also provides a computer program product is provided, including an instruction which, when executed on a computer, causes a computer to perform the method in the above-mentioned embodiments.

Terms such as “first”, “second” and the like in the specification and claims of the present disclosure as well as in the above drawings are intended to distinguish different objects, but not intended to define a particular order.

The term such as “and/or” in the embodiments of the present disclosure is merely used to describe an association between associated objects, which indicates that there may be three relationships, for example, A and/or B may indicate presence of A only, of both A and B, and of B only.

In the embodiments of the present disclosure, expressions such as “exemplary” or “for example” are used to indicate illustration of an example or an instance. In the embodiments of the present disclosure, any embodiment or design scheme described as “exemplary” or “for example” should not be interpreted as preferred or advantageous over other embodiments or design schemes. In particular, the use of “exemplary” or “for example” is aimed at presenting related concepts in a specific manner.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

The computer-readable non-transitory media includes all types of computer readable media, including magnetic storage media, optical storage media, and solid state storage media and specifically excludes signals. It should he understood that the software can be installed in and sold with a router, client, or other network device. Alternatively the software can be obtained and loaded into a device, including obtaining the software via a disc medium or from any manner of network or distribution system, including, for example, from a server owned by the software creator or from a server not owned but used by the software creator. The software can be stored on a server for distribution over the Internet, for example.

In alternative embodiments, some or all of the software can be replaced by dedicated hardware including custom integrated circuits, gate arrays, FPGAs, PLDs, and special purpose computers. In one embodiment, software (stored on a storage device) implementing one or more embodiments is used to program one or more processors. The one or more processors can be in communication with one or more computer readable media/storage devices, peripherals and/or communication interfaces. In alternative embodiments, some or all of the software can be replaced by dedicated hardware including custom integrated circuits, gate arrays, FPGAs, PLDs, and special purpose computers. In embodiments, the term “unit” may include a circuit (or integrated circuit) or software component.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope of the invention be defined by the claims appended hereto.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate, preclude or suggest that a combination of these measures cannot be used to advantage. A computer program may be stored or distributed on a suitable medium, such as an optical storage medium or a solid-state medium supplied together with, or as part of, other hardware, but may also be distributed in other forms, such as via the Internet or other wired or wireless telecommunication systems.

1. A group communication method, comprising:
acquiring, by a first user device, a group identifier (ID), wherein the group identifier is used for identifying a group comprising at least the first user device and a second user device;
acquiring, by the first user device, at least one parameter;
determining, by the first user device, a current destination ID according to the group ID and the at least one parameter, wherein the current destination ID is used for identifying the second user device in the group; and
transmitting, by the first user device, to the second user device a packet carrying the current destination ID.

2. The method according to claim 1, wherein the determining, by the first user device, the current destination ID according to the group ID and the at least one parameter comprises:
determining, by the first user device, whether a triggering condition is satisfied;
in response to determining that the triggering condition is satisfied, generating, by the first user device, the current destination ID according to the group ID and the at least one parameter; and
in response to determining that the triggering condition is not satisfied, determining, by the first user device, a previously generated destination ID as the current destination ID.

3. The method according to claim 2, wherein the generating, by the first user device, the current destination ID according to the group ID and the at least one parameter comprises:
determining, by the first user device, a random number; and
generating, by the first user device, the current destination ID based on the group ID using a hash function and the random number.

4. The method according to claim 3, wherein the determining, by the first user device, a random number comprises:
determining, by the first user device, whether a generating condition for generating the random number is satisfied;
in response to determining that the generating condition is satisfied, generating, by the first user device, the random number; and
in response to determining that the generating condition is not satisfied, using, by the first user device, the previously generated random number as the random number.

5. The method according to claim 4, wherein the transmitting, by the first user device, to the second user device a packet carrying the current destination ID comprises:
in response to determining that the generating condition is satisfied, encrypting, by the first user device, the random number with the at least one parameter; and transmitting, by the first user device, to the second user device a packet carrying the current destination ID and the encrypted random number.

6. The method according to claim 4, wherein the transmitting, by the first user device, to the second user device a packet carrying the current destination ID comprises:
in response to determining that the generating condition is not satisfied, transmitting, by the first user device, to the second user device a packet carrying the current destination ID.

7. The method according to claim 1, wherein the determining, by the first user device, the current destination ID according to the group ID and the at least one parameter comprises:
generating, by the first user device, the current destination ID based on the group ID using the at least one parameter and a predefined algorithm.

8. The method according to claim 7, wherein the transmitting, by the first user device, to the second user device a packet carrying the current destination ID comprises:
generating, by the first user device, a public key using the group ID and the at least one parameter;
encrypting, by the first user device, the packet carrying the current destination ID with the public key; and
transmitting, by the first user device, the encrypted packet to the second user device.

9. The method according to claim 1, wherein the current destination ID is a destination layer 2 ID (L2 ID) in Sidelink prose direct communication.

10. A group communication method, comprising:
receiving, by a second user device, a packet carrying a current destination identifier (ID), wherein the current destination ID is used for identifying the second user device in a group, and the group comprises at least a first user device and the second user device;
acquiring, by the second user device, a group ID, wherein the group ID is used for identifying the group;
acquiring, by the second user device, at least one parameter;
determining, by the second user device, a local destination ID according to the group ID and the at least one parameter; and
verifying, by the second user device, the current destination ID in the received packet with the local destination ID.

11. The method according to claim 10, wherein the determining, by the second user device, the local destination ID according to the group ID and the at least one parameter comprises:
generating, by the second user device, the local destination ID based on the group ID using the at least one parameter and a predefined algorithm.

12. The method according to claim 11, wherein the verifying, by the second user device, the current destination ID in the received packet with the local destination ID comprises:
obtaining, by the second user device, a private key, wherein the private key corresponds to a public key generated by the first user device based on the group ID and the at least one parameter;
decrypting, by the second user device, the packet carrying the current destination ID using the private key; and
comparing, by the second user device, the current destination ID in the decrypted packet with the local destination ID.

13. The method according to claim 10, wherein after the verifying, by the second user device, the current destination ID in the received packet with the local destination ID, the method further comprises:
in a case where the current destination ID in the received packet is as same as the local destination ID, starting, by the second user device, to monitor a packet using the current destination ID.

14. A first user device, comprising:
at least one processor; and
a memory coupled to the processor and having program instructions stored thereon which, when executed by the at least one processor, cause the first user device to:
acquire a group identifier (ID), wherein the group identifier is used for identifying a group comprising at least the first user device and a second user device;
acquire at least one parameter;
determine a current destination ID according to the group ID and the at least one parameter, wherein the current destination ID is used for identifying the second user device in the group; and
transmit to the second user device a packet carrying the current destination ID.

15. The first user device according to claim 14, wherein the program instructions further cause the first user device to:
determine whether a triggering condition is satisfied;
in response to determining that the triggering condition is satisfied, generate the current destination ID according to the group ID and the at least one parameter; and
in response to determining that the triggering condition is not satisfied, determine a previously generated destination ID as the current destination ID.

16. The first user device according to claim 15, wherein the program instructions further cause the first user device to:
determine a random number; and
generate the current destination ID based on the group ID using a hash function and the random number.

17. The first user device according to claim 14, wherein the program instructions further cause the first user device to generate the current destination ID based on the group ID using the at least one parameter and a predefined algorithm.

18. The first user device according to claim 17, wherein the program instructions further cause the first user device to:
generate a public key using the group ID and the at least one parameter;
encrypt the packet carrying the current destination ID with the public key; and
transmit the encrypted packet to the second user device.

19. The first user device according to claim 14, wherein the current destination ID is a destination layer 2 ID (L2 ID) in Sidelink prose direct communication.

20. A second user device, comprising:
at least one processor; and
a memory coupled to the processor and having program instructions stored thereon which, when executed by the at least one processor, cause the second user device to:
receive a packet carrying a current destination identifier (ID), wherein the current destination ID is used for identifying the second user device in a group, and the group comprises at least a first user device and the second user device;
acquire a group ID, wherein the group ID is used for identifying the group;
acquire at least one parameter;
determine a local destination ID according to the group ID and the at least one parameter; and
verify the current destination ID in the received packet with the local destination ID.

21. The second user device according to claim 20, wherein the program instructions further cause the second user device to generate the local destination ID based on the group ID using the at least one parameter and a predefined algorithm.

22. The second user device according to claim 21, wherein the program instructions further cause the second user device to:
obtain a private key, wherein the private key corresponds to a public key generated by the first user device based on the group ID and the at least one parameter;
decrypt the packet carrying the current destination ID using the private key; and
compare the current destination ID in the decrypted packet with the local destination ID.

23. The second user device according to claim 20, wherein wherein the program instructions further cause the second user device to:
starte to monitor a packet using the current destination ID in a case where the current destination ID in the received packet is as same as the local destination ID.
